(19) United States
(12) Patent Application Publication
(10) Pub. No.: US 2023/0365371 A1
(43) Pub. Date: Nov. 16, 2023

(54) TAPE APPLICATOR HEAD WITH GUIDES

(71) Applicant: Vivid Laminating Technologies Ltd, Ashby de la Zouch (GB)

(72) Inventor: Gavin Ward, Ashby de la Zouch (GB)

(21) Appl. No.: 18/314,528

(22) Filed: May 9, 2023

(30) Foreign Application Priority Data
May 10, 2022 (GB) 2206796.1

(51) Int. Cl. B65H 35/00; B31B 50/72

(52) U.S. Cl. CPC B65H 35/0013; B31B 50/72; B65H 35/0086; B31B 2100/00

(57) ABSTRACT

A tape applicator head is described. The tape applicator head includes an applicator roller for applying a strip of tape to a workpiece positioned on a flatbed of an apparatus such as a flatbed digital cutter. A support of the tape applicator head supports a tape roll. A plurality of guides are each configured for guiding a different tape width. The tape applicator head includes a guide mount configured for removably mounting a selected one of the plurality of guides. The mounted guide is positioned to guide tape from the tape roll to the applicator roller.

### CROSS-REFERENCE TO RELATED APPLICATION(S)

This application claims priority to GB Pat. Application No. 2206796.1 filed on May 10, 2022, the entire content of which is incorporated by reference herein.

### TECHNICAL FIELD

The invention relates to a tape applicator head for applying strips of tape to a workpiece. The workpiece may comprise a sheet of material such as card or paper stock, for example.

The tape applicator head includes one or more guides for guiding the tape. The tape applicator head may be part of an apparatus such as a digital flatbed cutter where the tape applicator head is mounted to a head unit of the apparatus, and where the head unit is movable in a plane above a flatbed on which the workpiece can be positioned.

### BACKGROUND OF THE INVENTION

It is known to apply a strip of tape to a workpiece using a hand-held tape gun.

It is also known to apply a strip of tape to a workpiece using a tape applicator. A conventional tape applicator typically comprises at least one tape applicator head which applies a strip of tape in a transferring direction, i.e., the direction along which the workpiece is moved. The position of each tape applicator head can be adjusted in a lateral direction that is perpendicular to the transferring direction. If two or more tape applicators are provided, multiple strips of tape can be applied to the workpiece in a single pass through the tape applicator.

The workpiece is normally fed past the tape applicator heads, which are independently controlled to apply a strip of tape to the workpiece. Each tape strip runs in the transferring direction and its length is determined by the tape applicator head. If it is necessary to apply tape strips to the workpiece in multiple directions - e.g., along all four edges of a rectangular workpiece, or to glue tabs of a packaging blank that are arranged in different directions - the tape strips must be applied in multiple passes through the tape applicator. For example, if the tape applicator has two tape applicator heads, tape strips can be applied to two opposite edges of a rectangular workpiece in a first pass. The workpiece is then rotated by 90° and passed through the tape applicator for a second time so that tape strips can be applied to the other two opposite edges of the workpiece.

Each tape applicator head can be controlled to apply a strip of tape of desired length to a particular part of the workpiece. Each tape applicator head typically includes a plurality of rollers which can be driven or non-driven. At least one roller is used to apply the tape to the surface of the workpiece (an “applicator roller”) and other rollers are guide rollers. The tape is typically supplied on a roll or spool and is fed down to the applicator roller. The tape can be fed around individual guide rollers, between pairs of counter-rotating guide rollers, or using one or more other guides. Each tape applicator head typically includes a support for supporting the tape roll and a knife or blade for cutting the tape to the desired length as it is being applied to the workpiece.

The tape applicator head can be used to apply any suitable sort of tape to the workpiece, e.g., double-sided adhesive tape.

The tape applicator can include a feed mechanism for feeding the workpiece past the tape applicator head(s).

Digital flatbed cutters are known. In a typical cutter of this type, a workpiece such as a sheet of card or paper stock is placed on a flatbed. An example of a digital flatbed cutter is the VELOBLADE® product supplied by Vivid Laminating Technologies Ltd of Matrix House, Norman Court, Ivanhoe Business Park, Ashby de la Zouch, Leicestershire, LE65 2UZ, United Kingdom. A cutter head is mounted above the flatbed on an assembly that can move the cutter head in a controlled way in a parallel plane above the flatbed (i.e., in a plane defined by an x-axis and a perpendicular y-axis). The cutter head includes a knife or blade for cutting the workpiece. The knife or blade can typically move vertically relative to the flatbed (i.e., in a z-axis direction that is perpendicular to both the x- and y-axes directions). In particular, the knife or blade can be moved between a first position where it is spaced apart from the workpiece and a second position where it is in contact with the workpiece for cutting.

The assembly can include a head unit on which the cutter head is mounted. The head unit can move in a first direction (i.e., a y-axis direction) along a support rail that extends over the flatbed. The support rail itself can move in a second direction (i.e., an x-axis direction) along side rails that are located at the sides of the flatbed, for example.

The cutter can include a feed mechanism for positioning a workpiece on the flatbed.

A creaser head can also be mounted on the head unit next to the cutter head. The creaser head can include a creaser wheel for creasing the workpiece. The creaser wheel can typically move vertically relative to the flatbed - in particular, the creaser wheel can be moved between a first position where it is spaced apart from the workpiece and a second position where it is in contact with the workpiece for creasing.

The head unit can be aligned precisely with the workpiece before the cutting and/or creasing process is started. For example, the head unit can include a camera and use optical recognition of one or more printed registration marks on the workpiece. Once the head unit has been precisely aligned relative to the workpiece positioned on the flatbed, the workpiece can be creased by the creaser head and/or cut by the cutter head based on information stored in a digital file. In particular, the digital file can include creasing information and/or cutting information for controlling the cutter. The workpiece can be creased and then cut or vice versa. After it has been cut and/or creased, the workpiece is removed from the flatbed.

It is often necessary to apply one or more strips of tape to a workpiece that has been cut using a digital flatbed cutter. For example, if the workpiece has been creased and cut to form a packaging blank that is to be folded and assembled to form a box or container, double-sided adhesive tape must often be applied to one or more glue tabs of the packaging blank. It is therefore necessary to either apply the strips of tape to the packaging blank manually using a hand-held tape gun, or to pass the packaging blank through a separate tape applicator one or more times.

GB 2100811.5 (unpublished) describes an apparatus (e.g., a digital flatbed cutter) with a flatbed on which a workpiece can be positioned. A tape applicator head includes an applicator roller for applying a strip of tape to the workpiece. The apparatus includes a head unit to which the tape applicator is mounted. The head unit is movable in a plane above the flatbed and at least the applicator roller is rotatable about an axis that is normal to the plane. Put another way, the head unit is movable along one or both of an x-axis direction and a perpendicular y-axis direction and at least the applicator roller is mounted to be rotatable about a z-axis that is perpendicular to the x- and y-axes. The applicator roller is also mounted to be rotatable about a longitudinal axis of the applicator roller that is parallel with the plane and the roller rotates about this longitudinal axis when the tape is being applied to the workpiece.

The tape applicator head further includes a support for supporting a tape roll and one or more guides for guiding the tape from the tape roll to the applicator roller.

The tape applicator head also includes a knife or blade for cutting the tape. The tape applicator head is controlled to apply a strip of tape of a particular length to the workpiece where the starting point of the tape strip is determined by positioning the tape applicator head over the workpiece, the direction or orientation of the tape strip is determined by the subsequent movement of the tape applicator head over the workpiece, and the length of the tape strip is determined by stopping and raising the tape applicator head and then cutting the tape.

The tape application information in a digital file that is used by the digital flatbed cutter will typically use the centre of the applicator roller as a reference point. To ensure accurate application of the tape strip to the workpiece, it is therefore important that the tape is guided accurately from the tape roll to the centre of the applicator roller.

It is desirable that the tape applicator head can be used to apply different tapes to the workpiece, including tapes of different widths.

It is also important that the workpiece remains on the flatbed during the taping process. It has been found that the workpiece can sometimes be lifted away from the flatbed when the applied tape is cut by the knife or blade. This can cause the workpiece to be repositioned on the flatbed, which in turn means that the workpiece is misaligned during any subsequent process.

### SUMMARY OF THE INVENTION

The present invention provides a tape applicator head for an apparatus, the tape applicator head comprising:
an applicator roller for applying a strip of tape to a workpiece positioned on a flatbed of the apparatus;
a support for supporting a tape roll;
a plurality of guides that are each configured for guiding a different tape width; and
a guide mount configured for removably mounting a selected one of the plurality of guides;
wherein the mounted guide is positioned to guide tape from the tape roll to the applicator roller. In particular, the mounted guide can be positioned between the tape roll support and the applicator roller.

Each guide can be a guide roller, e.g., have a substantially cylindrical construction.

Each guide can include a pair of tape edge guide members. The tape edge guide members can be defined by the sides of a groove or channel in the guide, for example. Each guide of the plurality of guides can have a groove or channel having a different width where the width corresponds to the width of the tape to be guided. If each guide is a guide roller, the groove or channel can be an annular groove or channel formed in its outer cylindrical surface.

The plurality of guides can include a first guide for guiding tape having a first width and a second guide for guiding tape having a second width, where the first and second widths are different. Any suitable number of different guides can be used with the tape applicator head and it will normally depend on how many different tape widths need to be accommodated. For example, if the tape applicator head will normally be used to apply two or three different tape widths, the user can select from two or three different guides where each guide is configured for guiding one of the tape widths.

The tape applicator head can include a plurality of guide sets, where each guide set includes a plurality of identical guides for guiding the same tape width. Each guide set is configured for guiding a different tape width. The tape applicator head can include a plurality of guide mounts, each guide mount configured for removably mounting a guide of a selected one of the plurality of guide sets. The mounted guides of each guide set can be positioned at spaced locations to more accurately guide tape from the tape roll to the applicator roller. In particular, the mounted guides can be positioned at spaced locations between the tape roll support and the applicator roller.

The tape applicator head can further include one or more non-removable or fixed guides, e.g., guide rollers, for guiding the tape to the applicator roller.

If a guide is designed to contact the exposed adhesive on the tape surface, it can be formed with a grooved or dimpled surface to reduce surface contact area. The guide can act as a brake and prevent unravelling of the tape, but it does not have sufficient surface contact area to become adhered to the tape. At least one such guide can be positioned close to the applicator roller so that the end of the tape is positioned properly preparatory to being applied to the workpiece by the applicator roller.

The tape applicator head can further comprise a plurality of spacers that each have a different thickness, wherein a selected one of the spacers is positioned between the tape roll and the support. When positioned, the spacer can ensure that the tape roll is positioned accurately in line with the centre of the applicator roller. The tape roll can be supported so as to be freely rotatable when tape is being removed from the tape roll and applied to the workpiece.

Each guide can be removably mounted between a pair of spaced plates of the tape applicator head. Each guide can be mounted so as to be freely rotatable.

The tape applicator head can include a knife or blade for cutting the tape.

The knife or blade can be mounted on a support that is movable between a rest position and a cutting position. The support can be pivotally mounted. The support can be pivoted between the rest position and the cutting position by an actuator.

The support can further include at least one retaining means configured to contact the workpiece when the support is in or approaching the cutting position. Each retaining means can be a wheel that is rotatably mounted to the support. The at least one retaining means is designed to prevent the workpiece from being lifted, e.g., from a flatbed on which it is placed, when the tape is being cut by the blade or knife of the tape applicator head. Such lifting can result in the workpiece being incorrectly positioned on the flatbed and this can cause problems with any subsequent taping or cutting or creasing operations.

At least the applicator roller, and optionally the whole of the tape applicator head, can move vertically relative to the flatbed (i.e., along a z-axis direction) so that the applicator roller can move into contact with the workpiece. In other words, at least the applicator roller can be mounted to be moved by an actuator between a first position where it is spaced apart from the workpiece and a second position where it is in contact with the workpiece for applying a strip of tape, and optionally where contact pressure is applied to the workpiece by the applicator roller. The support for mounting the blade or knife for cutting the tape can move along the z-axis with the applicator roller. After the tape strip has been applied to the workpiece, at least the applicator roller, and optionally the whole of the tape applicator head, can move back to the first position and the support is moved from the rest position to the cutting position to cut the tape close to the workpiece. As the tape is cut, the at least one retaining means of the support is preferably in contact with the workpiece to prevent it from being lifted. The support is then moved back to the rest position to pivot the blade or knife away from the applicator roller.

The tape applicator head can be controlled to apply a strip of tape of a particular length to the workpiece where the starting point of the tape strip is determined by positioning the tape applicator head over the workpiece, the direction or orientation of the tape strip is determined by the subsequent movement of the tape applicator head, and the length of the tape strip is determined by stopping and raising the tape applicator head and by cutting the tape.

The tape applicator head can be used to apply any suitable tape to the workpiece, including double-sided adhesive tape, silicone tape etc. In the case of double-sided adhesive tape, the tape will normally be applied to the workpiece with the backing layer still adhered; which backing layer is then subsequently removed by hand to expose the underlying adhesive. But it is also possible for the backing layer to be removed by the tape applicator head when the tape is applied to the workpiece, e.g., where the backing layer is gathered on a waste roll or spool.

The present invention further provides an apparatus comprising:
a flatbed on which a workpiece can be positioned;
a tape applicator head as described above; and
a head unit to which the tape applicator head is mounted;
wherein the head unit is movable in a plane above the flatbed and at least the applicator roller is rotatable about an axis that is normal to the plane. Put another way, the head unit is movable in the parallel plane along one or both of an x-axis direction and a perpendicular y-axis direction and at least the applicator roller of the tape applicator head is mounted to be rotatable about a z-axis that is perpendicular to the x-and y-axes. The applicator roller is also mounted to be rotatable about a longitudinal axis of the applicator roller that is parallel with the plane and it will be understood that the roller will rotate about this longitudinal axis when the tape is being applied to the workpiece.

The whole of the tape applicator head can rotate relative to the head unit about the z-axis.

The whole of the tape applicator head can also move up and down along the z-axis direction.

The apparatus can further include a control unit adapted to control the movement of the head unit. The movement of the head unit can be controlled by the control unit using a digital file with tape application information that is described in more detail below.

The apparatus can include a feed mechanism for positioning a workpiece on the flatbed. Any suitable feed mechanism can be used, e.g., a vacuum feed that can be integrated into the head unit or the support rail and which can be used to pick up an individual workpiece from a stack and position it on the flatbed.

The flatbed can be a conveyor which can be used to remove a workpiece from the apparatus.

The head unit can be mounted on a support rail that extends over the flatbed. The head unit can be moved along the support rail (i.e., along the y-axis direction) by an actuator. The support rail can be mounted on one or more side rails. The support rail can be moved along the one or more side rails (i.e., along the x-axis direction) by one or more actuators. The side rails can be located at opposite sides of the flatbed, for example, and are arranged substantially perpendicular to the support rail. The support rail and side rails allow the head unit to be moved in any direction under precise control in one or both of the x- and y-axes - i.e., in the parallel plane above the flatbed. It will be understood that other ways of moving the head unit under precise control can also be used.

The present invention further provides a tape applicator comprising the apparatus described above.

The present invention further provides a cutter (e.g., a digital flatbed cutter) comprising the apparatus described above, wherein the head unit further comprises a cutter head with a knife or blade for cutting the workpiece and/or a creaser head with a creaser wheel for creasing the workpiece.

The present invention further provides a method of using the apparatus described above to apply a strip of tape to a workpiece positioned on the flatbed, wherein at least the applicator roller is rotated about the axis that is normal to the plane so as to be aligned with a particular direction, and the head unit is moved in that direction over the flatbed with the applicator roller in contact with the workpiece.

In use, a workpiece is positioned on the flatbed using the feed mechanism. The head unit is precisely aligned with the workpiece on the flatbed. For example, the head unit can include a camera or other optical device and the control unit can use optical recognition of one or more printed registration marks on the workpiece or the outline of the workpiece. The optical recognition allows the control unit to know the precise position and orientation of the workpiece on the flatbed and to precisely align the head unit with the workpiece. Once the head unit has been precisely aligned, one or more strips of tape can also be applied to the workpiece using the tape applicator head. In particular, the tape applicator head is positioned over the workpiece by moving the head unit, at least the applicator roller is lowered to the second position where it contacts the workpiece and contact pressure is applied, and the head unit is moved in a particular direction (which may be along one or both of the x- and y-axes) with the applicator roller aligned with the particular direction and in contact with the workpiece to apply a strip of tape of desired length to the workpiece. The applicator roller is raised to the first position and the tape applicator head is repositioned over the workpiece by moving the head unit. The tape application process is repeated until all of the tape strips have been applied when the process is ended. During the tape application process, the applicator roller can be rotated about the z-axis to allow tape strips to be applied to the workpiece in any direction. The applicator roller will be rotated about the z-axis so that it is aligned with the direction in which the head unit is moved when the tape is being applied to the workpiece. This is different from a conventional tape applicator where tape strips can only be applied to the workpiece along the transferring direction, i.e., the direction in which the workpiece is passed by the stationary tape applicator head(s).

In the case of a digital flatbed cutter, the workpiece can also be creased by the creaser head and/or cut by the cutter head based on a digital file. Typically, the workpiece will be creased, taped, and finally cut. But it will be understood that the cutting, creasing and taping processes can be carried out in any order and can be split into several sub-processes that are carried out in any order - so that two separate cutting sub-processes may be carried out with an interposing creasing process or tape application process, for example.

The digital flatbed cutter can be controlled using a digital file. The digital file includes tape application information which specifies where each tape strip should be applied to the workpiece. The digital file also includes cutting information and/or creasing information which specifies where the workpiece should be cut and/or creased.

### DRAWINGS

FIG. 1 is a schematic front view of a digital flatbed cutter according to the present invention;

FIG. 2 is a schematic side view of the cutter of FIG. 1;

FIG. 3 is a schematic side view of a tape applicator head according to the present invention;

FIG. 4 is a schematic front view of the tape applicator head of FIG. 3;

FIG. 5 is a schematic front view of a pair of guide rollers;

FIG. 6 is a schematic detail view showing an arrangement of guide rollers;

FIG. 7 is a schematic side view showing the tape applicator head in a second position where the applicator roller is in contact with a workpiece and the blade support is in a rest position;

FIG. 8 is a schematic side view showing the tape applicator head in a first position where the applicator roller is spaced away from the workpiece and the blade support is in a cutting position;

FIG. 9 is a visual representation of a digital file for controlling the cutter according to the present invention;

FIG. 10 is a top view of a workpiece; and

FIG. 11 is a packaging blank for a container produced from the workpiece using the cutter according to the present invention.

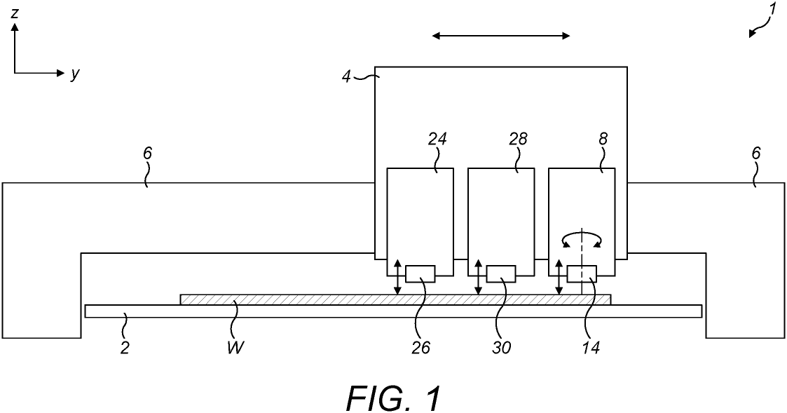

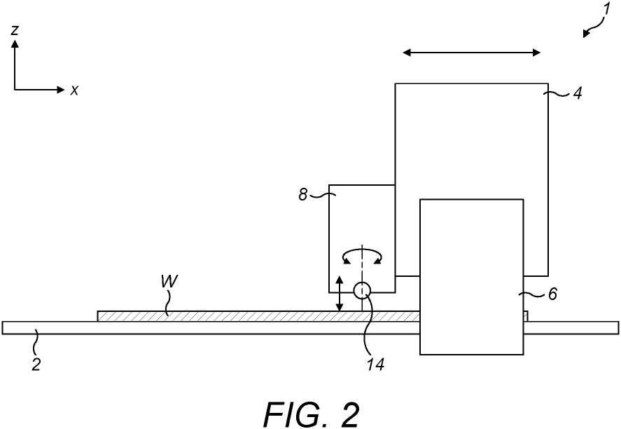

As shown in FIGS. 1 and 2, a digital flatbed cutter 1 includes a flatbed 2 on which a workpiece W can be positioned.

A head unit 4 is mounted above the flatbed 2. The head unit 4 is mounted on a support rail 6 and can move from side to side along the support rail (i.e., along a y-axis direction) by a suitable actuator (not shown). The support rail 6 is mounted on side rails (not shown) and can move backwards and forwards along the side rails (i.e., along an x-axis direction) by one or more suitable actuators (not shown). The actuators are controlled by a control unit (not shown) which can include a suitable processor and a user input device such as a touch display screen or keypad, for example. By controlling the actuators, the head unit 4 can be positioned precisely and can be moved in any direction in a parallel plane above the flatbed 2 defined by the perpendicular x- and y-axes.

The head unit 4 includes a tape applicator head 8, which is just shown schematically in FIGS. 1 and 2.

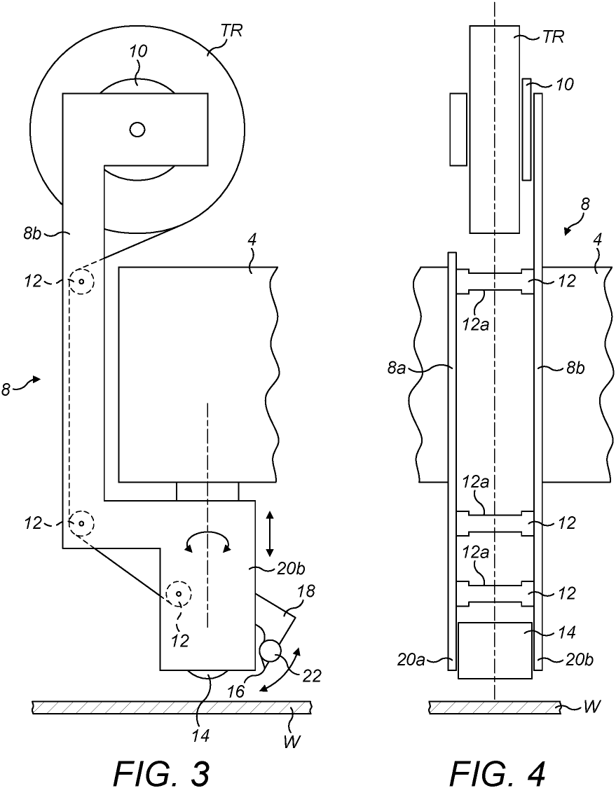

An example of a tape applicator head 8 is shown in more detail in FIGS. 3 to 8.

The tape applicator head 8 includes a pair of spaced plates 8a, 8b. An upper part of the plate 8b defines an L-shaped support bracket for rotatably supporting a tape roll TR. The support bracket is capable of supporting tape rolls having different widths. To ensure that the supported tape roll is properly aligned with the centre of an applicator roller 14 for applying a strip of tape to a workpiece, a spacer 10 can be positioned between the tape roll TR and the plate 8b. The spacer 10 can be selected from a plurality of spacers having different thicknesses. For example, if a first tape roll has a first width, the user may select a first spacer having a first thickness that is determined so that the first tape roll is aligned with the centre of the applicator roller 14, and if a second tape roll has a second width that is greater than the first width, the user may select a second spacer having a second thickness that is less than the first thickness and is determined so that the second tape roll is aligned with the centre of the applicator roller 14. The spacers can have different colours to indicate different thicknesses or suitability for use with a tape roll of a certain width. In FIG. 4 the dashed vertical line shows how, with the spacer 10 of selected thickness spacing the tape roll TR away from the plate 8b, the tape roll is accurately aligned with the centre of the applicator roller 14.

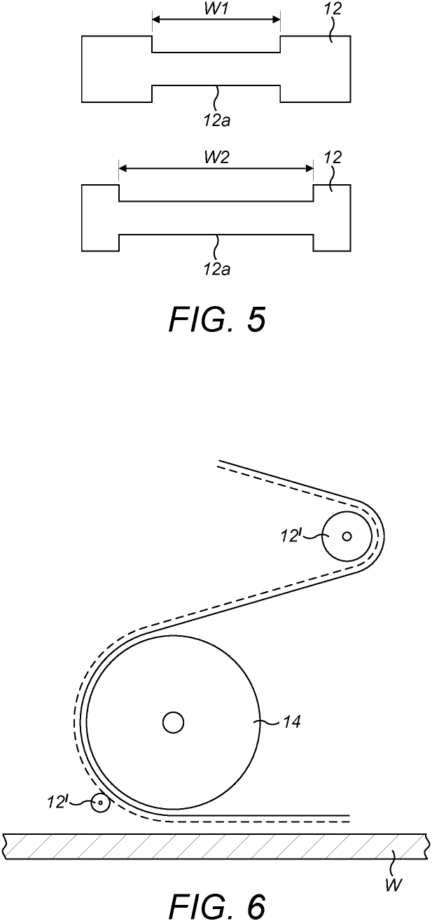

A plurality of guide rollers 12 are removably mounted between the plates 8a, 8b. Each guide roller 12 includes an annular groove or channel 12a having a width that corresponds to the tape width. The guide rollers 12 can be selected from a plurality of guide roller sets. For example, if a first tape roll has a first width, the user may select guide rollers from a first guide roller set where each guide roller has a groove or channel with a first width that corresponds to the first tape width, and if a second tape roll has a second width that is greater than the first width, the user may select guide rollers from a second guide roller set where each guide roller has a groove or channel with a second width that is greater than the first width and corresponds to the second tape width. The selected guide rollers 12 are removably mounted between the plates 8a, 8b and positioned at intervals to guide tape from the supported tape roll TR down to the applicator roller 14. FIG. 5 shows a pair of guide rollers 12 with different groove widths W1 and W2 which can be mounted to the tape applicator head 8. The first guide roller set could include a plurality of guide rollers with groove width W1 and the second guide roller set could include a plurality of guide rollers with groove width W2, for example. The guide rollers 12 can be removably mounted to the tape applicator head 8 using any suitable means, e.g., fixings that are inserted or screwed into the axial ends of the guide rollers through openings in the plates 8a, 8b.

The guide rollers 12 of each guide roller set can have different colours to indicate different groove or channel widths or suitability for use with a tape roll of a certain width.

The guide rollers 12 contact the backing liner that is adhered to the double-sided tape. One or more additional guide rollers 12′ can contact the other side of the tape where the adhesive is exposed. These additional guide rollers 12′ can be formed with a grooved or dimpled surface so that they have minimal surface contact area and do not become adhered to the tape. FIG. 6 shows an arrangement of guide rollers 12′ that may be located close to the applicator roller 14, for example. In FIG. 6, the double-sided tape is indicated by the dashed line and the backing liner is indicated by the solid line.

The tape applicator head 8 is mounted to be rotatable about an axis that is normal to the plane (i.e., about the z-axis). Consequently, the applicator roller 14 is also rotatable about the z-axis. This is in addition to the normal rotation of the applicator roller 14 about its longitudinal axis that is parallel to the plane and about which the applicator roller rotates when it is in contact with the workpiece and applying tape to the workpiece.

The tape applicator head 8 includes a knife or blade 16 for cutting the tape. The knife or blade 16 is mounted on a pivotable support 18. The support 18 is pivotally mounted to a pair of lower plates 20a, 20b of the tape applicator head 8 adjacent the applicator roller 14 and is moved between a rest position (FIGS. 3, 4 and 7) and a cutting position (FIG. 8) by an actuator (not shown). The support 18 includes a pair of retaining wheels 22 which are in contact with the workpiece W when the support is in the cutting position - see FIG. 8. Only a single wheel is visible in FIGS. 3, 7 and 8 but it will be readily understood that another wheel is provided on the other side of the support 18.

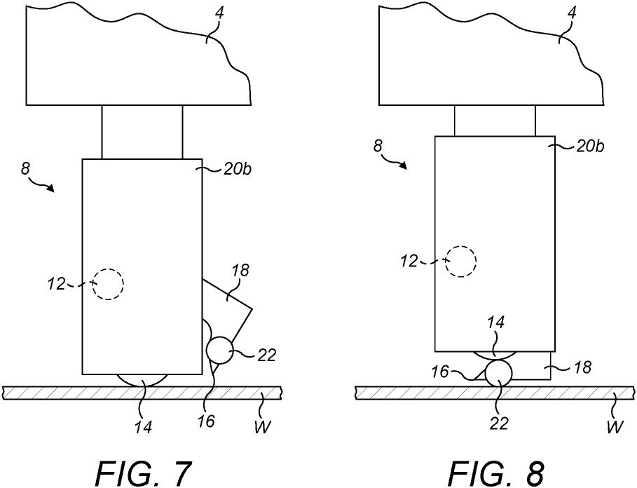

The tape applicator head 8 is mounted so that it can move along the axis that is normal to the plane (i.e., along the z-axis direction). The tape applicator head 8 can be moved by an actuator between a first position - shown in FIGS. 1 to 4 and 8 - where the applicator roller 14 is spaced apart from the workpiece W and a second position -shown in FIG. 7 - where the applicator roller is in contact with the workpiece for applying a strip of tape, and optionally where contact pressure is applied to the workpiece by the applicator roller.

To apply a strip of tape, when the tape applicator head 8 has been accurately positioned over the workpiece, the tape applicator head is lowered to the second position and the head unit 4 is moved in the plane above the flatbed (i.e., in the x- and/or y-direction) with the applicator roller 14 in contact with the workpiece so that the tape strip is adhered to the workpiece by the applicator roller. The tape applicator head 8 is moved back to the first position and the support 18 is pivoted to the cutting position to cut the tape close to the workpiece. As shown in FIG. 8, the retaining wheels 22 of the support contact and hold the workpiece W as the support 18 moves towards the cutting position. This prevents the workpiece W from being lifted off the flatbed 2 when the tape is cut by the blade or knife 16.

The head unit 4 also includes a cutter head 24 with a knife or blade 26 and a creaser head 28 with a creaser wheel 30. The tape applicator head 8, cutter head 24 and creaser head 28 are conveniently referred to below as “tool heads” and the applicator roller 14, knife or blade 26 and creaser wheel 30 as “tools”. The up and down movement of the tools in the z-axis direction is controlled by the control unit. The control unit can therefore position the head unit 4 over the workpiece W so that the appropriate tool head is at the required position, move the appropriate tool down into contact with the workpiece, move the head unit with the tool in contact with the workpiece to cut, crease or apply tape, move the tool up and away from the workpiece, and reposition the head unit over the workpiece. If the tool is the applicator roller 14, the tape applicator head 8 is rotated about the z-axis relative to the head unit 4 so that it is aligned with the direction in which the head unit will be moved over the flatbed 2 (i.e., so that its longitudinal axis is substantially perpendicular to the movement direction of the head unit).

The cutter 1 can include a feed mechanism (not shown) for positioning a workpiece on the flatbed 2. Any suitable feed mechanism can be used, e.g., a vacuum feed that can be integrated into the head unit 4 or the support rail 6 and which can be used to pick up an individual workpiece from a stack and position it on the flatbed 2.

The flatbed 2 can be a conveyor which can be used to remove a workpiece from the cutter 1.

The movement of the head unit 4 can be controlled by the control unit using a digital file.

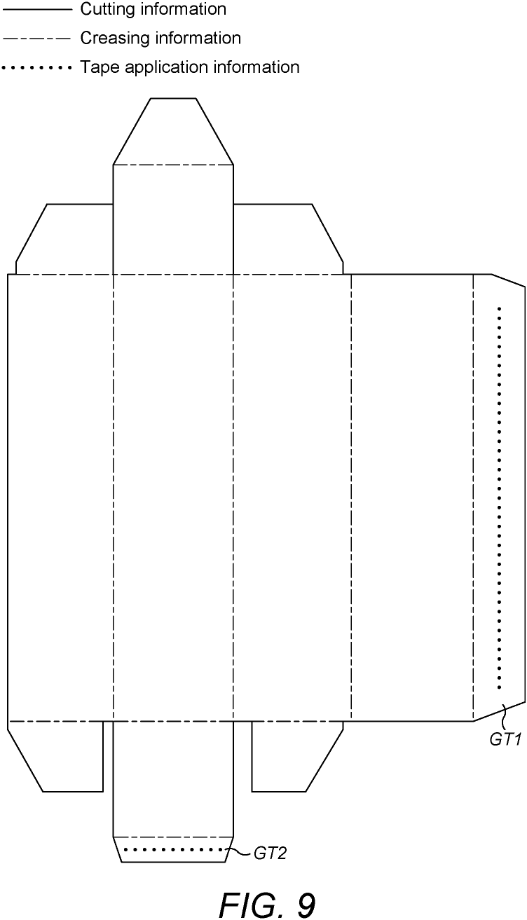

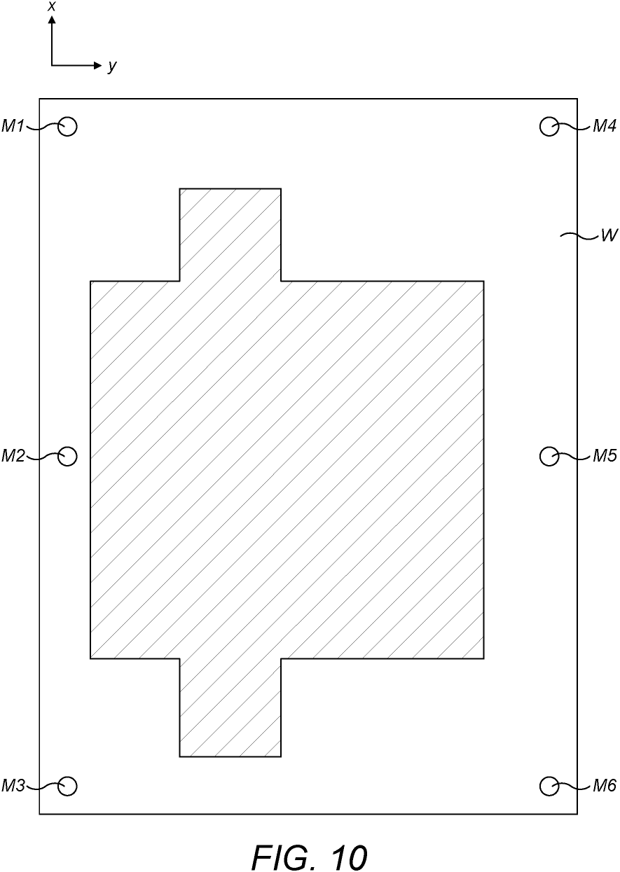

A visual representation of the digital file for a packaging blank is shown in FIG. 9 where cutting information is shown in solid line, creasing information is shown in dashed line and tape application information is shown in dotted line. In particular, the solid line indicates where the workpiece W shown in FIG. 10 should be cut by the cutter head 24, the dashed line indicates where the workpiece should be creased by the creaser head 28, and the dotted line indicates where a strip of tape of pre-determined width should be applied to the workpiece.

The workpiece W shown in FIG. 10 is a printed sheet of card stock. The workpiece W has printed areas that are indicated by the shading and which will be the outer surfaces of an assembled container. The workpiece W also includes six printed registration marks M1, M2, ..., M6.

The workpiece W shown in FIG. 10 is positioned on the flatbed 2 using the feed mechanism (not shown). A stack of identical workpieces can be located at an end of the flatbed 2 and an individual workpiece can be picked from the stack and positioned on the flatbed. The head unit 4 is precisely aligned with the workpiece W. For example, the head unit 4 can include a camera (not shown) and the control unit can use optical recognition of the printed registration marks M1, M2, ..., M6 to determine the precise position and orientation of the workpiece W on the flatbed 2. Once the head unit 4 has been precisely aligned relative to the workpiece, the workpiece can be creased by the creaser head 28, tape can be applied by the tape applicator head 14, and it can be cut by the cutter head 24 based on the respective information in the digital file. More particularly, after the workpiece W has been creased, in a tape application process, the head unit 4 can be positioned over a first glue tab GT1, the applicator roller 14 can be rotated about the z-axis to be aligned with the x-axis and moved down into contact with the workpiece, the head unit can be moved in the x-axis direction to apply a first tape strip S1 to the first glue tab GT1, the applicator roller can be moved up and away from the workpiece, the head unit can be re-positioned over a second glue tab GT2, the applicator roller can be rotated about the z-axis to be aligned with the y-axis and moved down into contact with the workpiece, the head unit can be moved in the y-axis direction to apply a second tape strip S1 to the second glue tab GT2, and the applicator roller 14 can be moved up and away from the workpiece. (This assumes that the workpiece W has been positioned on the flatbed 2 such that its edges are exactly aligned with the x-and y-axes of the cutter. In practice, the edges of the workpiece W are likely to be misaligned with the x- and y-axes of the cutter such that the head unit 4 is moved along directions that are angled slightly with respect to the x-axis direction and the y-axis direction with the tape applicator head 8 being rotated about the z-axis accordingly.) It will be understood that the applicator roller 14 is not limited to applying tape strips that are aligned with the x-axis direction or the y-axis direction. In practice, the tape applicator head 8 can be rotated about the z-axis to be aligned with any direction in which the head unit 4 can be moved. For example, the applicator roller 14 can be used to apply a diagonal tape strip that is not aligned with either the x-axis direction or the y-axis direction. In some arrangements, the applicator roller 14 can be rotated about the z-axis while it is in contact with the workpiece and is applying tape if the movement direction of the head unit 4 changes.

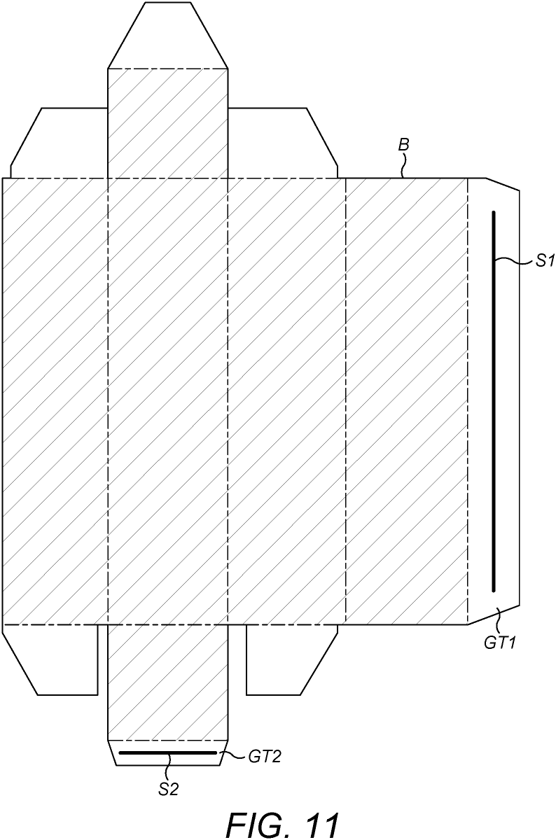

FIG. 11 shows a finished packaging blank B for a container with the tape strips S1 and S2 applied to the glue tabs GT1 and GT2. If the tape strips S1, S2 are double-sided tape, the backing layer can be removed to expose the adhesive and the packaging blank can be folded and assembled to form a container.

1. A tape applicator head for an apparatus, the tape applicator head comprising:
an applicator roller for applying a strip of tape to a workpiece positioned on a flatbed of the apparatus;
a support for supporting a tape roll;
a plurality of guides that are each configured for guiding a different tape width; and
a guide mount configured for removably mounting a selected one of the plurality of guides;
wherein the mounted guide is positioned to guide tape from the tape roll to the applicator roller.

2. The tape applicator head of claim 1, wherein each guide is a guide roller.

3. The tape applicator head of claim 1, wherein each guide includes a pair of tape edge guide members.

4. The tape applicator head of claim 3, wherein the tape edge guide members are defined by the sides of a channel or groove in the guide.

5. The tape applicator head of claim 1, further comprising a plurality of spacers that each have a different thickness, wherein a selected one of the spacers is positioned between the tape roll and the support.

6. The tape applicator head of claim 1, further comprising a knife or blade for cutting the tape.

7. The tape applicator head of claim 6, wherein the knife or blade is mounted on a support that is movable between a rest position and a cutting position.

8. The tape applicator head of claim 7, wherein the support is pivotally mounted.

9. The tape applicator head of claim 7, wherein the support further comprises at least one retaining means configured to contact the workpiece when the support is in the cutting position.

10. The tape applicator head of claim 9, wherein each retaining means is a wheel that is rotatably mounted to the support.

11. An apparatus comprising:
a flatbed on which a workpiece can be positioned;
a tape applicator head comprising:
an applicator roller for applying a strip of tape to the workpiece positioned on the flatbed;
a support for supporting a tape roll;
a plurality of guides that are each configured for guiding a different tape width; and
a guide mount configured for removably mounting a selected one of the plurality of guides; and
a head unit to which the tape applicator head is mounted;
wherein the mounted guide is positioned to guide tape from the tape roll to the applicator roller; and
wherein the head unit is movable in a plane above the flatbed and at least the applicator roller is rotatable about an axis that is normal to the plane.

12. The apparatus of claim 11, wherein at least the applicator roller is movable along the axis that is normal to the plane.

13. The apparatus of claim 11, further comprising a control unit adapted to control the movement of the head unit.

14. A tape applicator comprising:
a flatbed on which a workpiece can be positioned;
a tape applicator head comprising:
an applicator roller for applying a strip of tape to the workpiece positioned on the flatbed;
a support for supporting a tape roll;
a plurality of guides that are each configured for guiding a different tape width; and
a guide mount configured for removably mounting a selected one of the plurality of guides; and
a head unit to which the tape applicator head is mounted;
wherein the mounted guide is positioned to guide tape from the tape roll to the applicator roller; and
wherein the head unit is movable in a plane above the flatbed and at least the applicator roller is rotatable about an axis that is normal to the plane.

15. A cutter comprising:
a flatbed on which a workpiece can be positioned;
a tape applicator head comprising:
an applicator roller for applying a strip of tape to the workpiece positioned on the flatbed;
a support for supporting a tape roll;
a plurality of guides that are each configured for guiding a different tape width; and
a guide mount configured for removably mounting a selected one of the plurality of guides; and
a head unit to which the tape applicator head is mounted;
wherein the mounted guide is positioned to guide tape from the tape roll to the applicator roller; and
wherein the head unit is movable in a plane above the flatbed and at least the applicator roller is rotatable about an axis that is normal to the plane.

16. The cutter of claim 15, wherein the head unit further comprises a cutter head with a knife or blade for cutting the workpiece.

17. The cutter of claim 15, wherein the head unit further comprises a creaser head with a creaser wheel for creasing the workpiece.
